(19) United States
(12) Patent Application Publication
(10) Pub. No.: US 2021/0322989 A1
(43) Pub. Date: Oct. 21, 2021

(54) CONSTANT TEMPERATURE CIRCULAR ACCELERATED LOADING TEST SYSTEM

(71) Applicant: Shandong Jiaotong University, Jinan, Shandong (CN)

(72) Inventors: Peng ZHANG, Jinan, Shandong (CN); Jinxiang FENG, Jinan, Shandong (CN); Jiuhong RUAN, Jinan, Shandong (CN); Zhiguang GUAN, Jinan, Shandong (CN); Jiwei ZHANG, Jinan, Shandong (CN); Fuguang YANG, Jinan, Shandong (CN); Xingyu GUO, Jinan, Shandong (CN); Qian JIA, Jinan, Shandong (CN); Qingzhen WU, Jinan, Shandong (CN); Huijun WANG, Jinan, Shandong (CN); Ying HAN, Jinan, Shandong (CN)

(73) Assignee: Shandong Jiaotong University, Jinan, Shandong (CN)

(21) Appl. No.: 17/273,395

(22) PCT Filed: Jan. 29, 2019
(86) PCT No.: PCT/CN2019/073740

§ 371 Date: Mar. 4, 2021

(30) Foreign Application Priority Data
Sep. 4, 2018 (CN) 201811022269.4

(51) Int. Cl. B01L 7/02

(52) U.S. Cl. CPC B01L 7/02

(57) ABSTRACT

A constant temperature circular accelerated loading test system includes: a chassis; a motor reducer and a circular loading wheel group in the middle of the chassis, wherein the motor reducer provides power for the circular loading wheel group, and the circular loading wheel group implements a rolling test on a ground during rotation; a thermally insulated assembly on the chassis, the circular loading wheel group is located in a thermally insulated inner cavity of the thermally insulated assembly; a constant temperature unit on the chassis; a control cabinet on the chassis, wherein the control cabinet is connected to and controls the constant temperature unit and the motor reducer, respectively.

### CROSS-REFERENCE TO RELATED APPLICATION

This application is a Section 371 National Stage Application of International Application No. PCT/CN2019/073740, filed on Jan. 29, 2019, entitled “CONSTANT TEMPERATURE CIRCULAR ACCELERATED LOADING TEST SYSTEM,” which claims priority to Chinese Application No. 201811022269.4, filed on Sep. 4, 2018, incorporated herein by reference in their entirety.

### TECHNICAL FIELD

The present disclosure relates to the field of accelerated loading test system technology, and in particular, to a constant temperature circular accelerated loading test system.

### BACKGROUND

Existing circular accelerated loading test system neither has conditions for constant temperature experiments, nor has conditions for constant temperature water bath experiments, thereby resulting in that experiments under constant temperature conditions are difficult to be implemented.

### SUMMARY

A constant temperature circular accelerated loading test system includes: a chassis; a motor reducer and a circular loading wheel group in the middle of the chassis, wherein the motor reducer provides power for the circular loading wheel group, and the circular loading wheel group implements a rolling test on a ground during rotation; a thermally insulated assembly on the chassis, wherein the circular loading wheel group is located in a thermally insulated inner cavity of the thermally insulated assembly; a constant temperature unit on the chassis; a control cabinet on the chassis, wherein the control cabinet is connected to and controls the constant temperature unit and the motor reducer, respectively.

Specifically, the thermally insulated assembly includes a chassis thermally insulated inner cavity and a lower thermally insulated curtain, the chassis thermally insulated inner cavity has a cavity with an opening facing downwards, the circular loading wheel group is located in the cavity, and the lower thermally insulated curtain is wrapped at a lower part of the chassis thermally insulated cavity and sagged naturally to the ground.

Further, the test system also includes: adjustable legs for adjusting a vertical height of the chassis.

Specifically, the number of the adjustable legs is an even number, and the even-numbered adjustable legs are placed vertically and connected to the chassis symmetrically.

Further, the test system also includes: a water bath fixing assembly on the chassis and below the circular loading wheel group. The water bath fixing assembly further includes: a water heating and circulation device on a side of the chassis; a water bath below the circular loading wheel group.

Further, the test system also includes: a travel wheel assembly on a bottom of the chassis.

### BRIEF DESCRIPTION OF THE DRAWINGS

FIG. 1 is a front view of a structure according to a first embodiment of the present disclosure;

FIG. 2 is a cross-sectional view of an enlarged structure in A-A direction of FIG. 1;

FIG. 3 is a front view of a structure according to a second embodiment of the present disclosure; and

FIG. 4 is a front view of a structure according to a third embodiment of the present disclosure.

### LIST OF REFERENCE NUMERALS

1. constant temperature unit,
2. chassis,
3. lower thermally insulated curtain,
4. motor reducer,
5. circular loading wheel group,
6. travel wheel assembly,
7. adjustable leg,
8. control cabinet,
9. chassis thermally insulated cavity,
10. water bath,
11. water heating and circulation device.

### DETAILED DESCRIPTION OF EMBODIMENTS

Hereinafter, exemplary embodiments of the present disclosure will be described in more detail with reference to accompanying drawings in the specification. Although the accompanying drawings in the specification show exemplary embodiments of the present disclosure, it should be understood that the present disclosure may be implemented in various forms and should not be limited by the embodiments set forth herein. Rather, these embodiments are provided to enable a more thorough understanding of the present disclosure and to fully convey the scope of the present disclosure to those skilled in the art.

In order to better illustrate the present disclosure, the technical solution is now further described in conjunction with specific embodiments and the accompanying drawings in the specification. Although specific implementations are described in the embodiments, they are not intended to limit the present disclosure. Anyone with ordinary knowledge in the technical field may make slight changes and retouching without departing from the spirit and scope of the present disclosure, so the protection scope of the present disclosure should be defined by the claims.

### First Embodiment

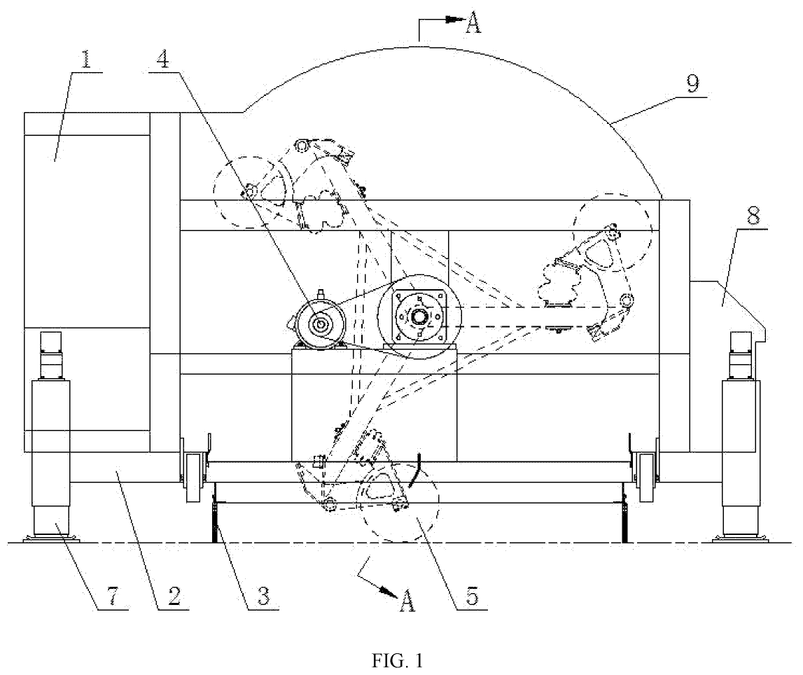

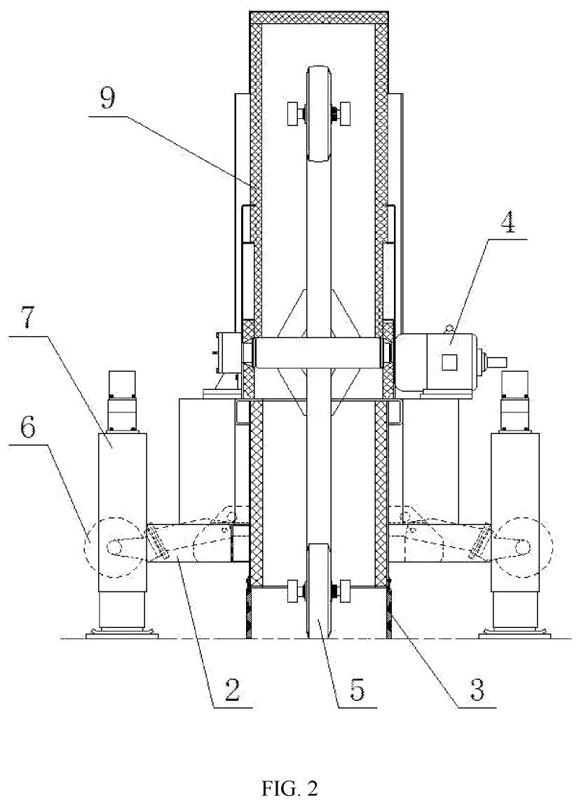

As shown in FIGS. 1 and 2, the present disclosure provides a constant temperature circular accelerated loading test system, which includes the following structures: a chassis 2; a motor reducer 4 and a circular loading wheel group 5 in the middle of the chassis 2; a thermally insulated assembly on the chassis 2; a constant temperature unit 1 on the chassis 2; and a control cabinet 8 on the chassis 2. The motor reducer 4 provides power for the circular loading wheel group 5, and the circular loading wheel group 5 performs a rolling test on a ground during rotation. The thermally insulated assembly includes a chassis thermally insulated inner cavity 9 and a lower thermally insulated curtain 3. The chassis thermally insulated inner cavity 9 has a cavity with an opening facing downwards. The circular loading wheel group 5 is located in the cavity. The lower thermally insulated curtain 3 is wrapped at a lower part of the chassis thermally insulated cavity 9 and sagged naturally to the ground. The constant temperature unit 1 is, for example, GDW-036 provided by Shanghai Jinyou Test Equipment Co., Ltd. or Shanghai Jinghong Test Equipment Co., Ltd. The control cabinet 8 is connected to and controls the constant temperature unit 1 and the motor reducer 4, respectively.

The test system further includes adjustable legs 7 for adjusting a vertical height of the chassis 2. The number of the adjustable legs 7 is an even number, and the even-number adjustable legs 7 are placed vertically and connected to the chassis 2 symmetrically. Four legs 7 are taken as an example in the embodiment.

### Second Embodiment

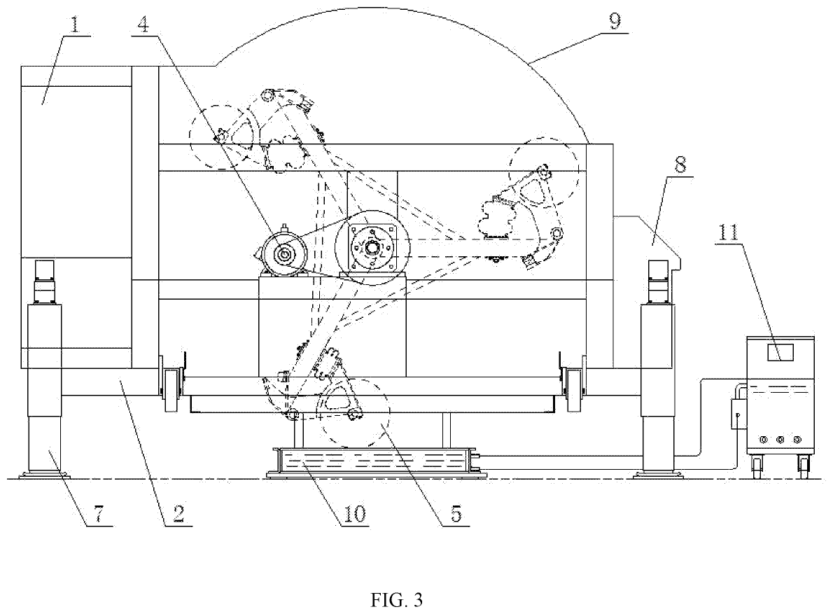

As shown in FIG. 3, based on the structure of the first embodiment, the test system further includes: a water bath fixing assembly on the chassis 2 and below the circular loading wheel group 5.

The water bath fixing assembly further includes: a water heating and circulation device 11 on a side of the chassis 2; and a water bath 10 below the circular loading wheel group 5. For example, the water bath may be the high-temperature constant temperature water bath BH8102 provided by Hangzhou Baoheng Constant Temperature Technology Co., Ltd., or the constant temperature water bath NKSY-15 provided by Changzhou Nuoji Instrument Co., Ltd.

### Third Embodiment

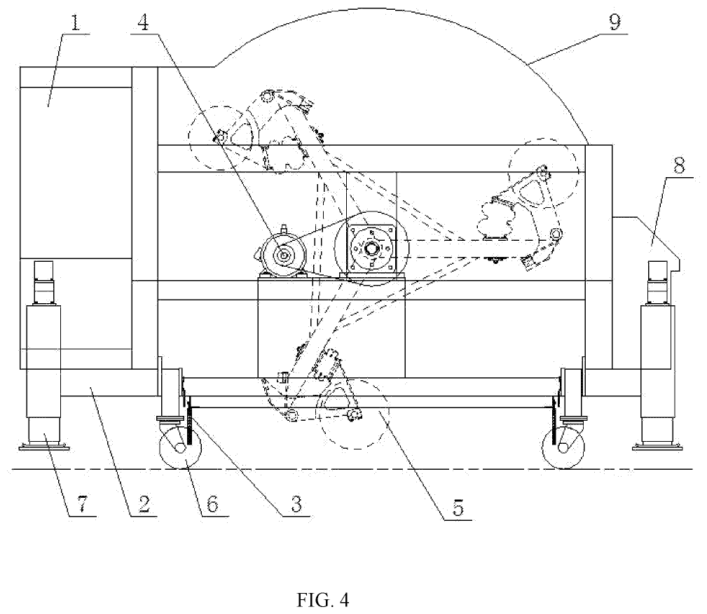

As shown in FIG. 4, based on the structure of the first embodiment, the test system further includes: a travel wheel assembly 6 on a bottom of the chassis 2, so that the chassis 2 may be easily moved.

Embodiments of the present disclosure provide a constant temperature circular accelerated loading test system, which solves the problem that the existing circular accelerated loading test system may not implement accelerated loading experiments under constant temperature and accelerated loading experiments under constant temperature water bath.

Compared with the related art, the constant temperature circular accelerated loading test system according to the present disclosure has the following beneficial effects: the test system according to the present disclosure is simple in structure, is in large integration degree, and is easily moved; and the test system according to the present disclosure may realize low energy consumption for constant temperature experiment conditions and constant temperature water bath conditions, and solves the problem that the existing circular accelerated loading test system may not implement accelerated loading experiments under constant temperature and accelerated loading experiments under constant temperature water bath; moreover, the test system according to the present disclosure is easy to assemble and disassemble, and has a high reliability.

Although the present disclosure has been described according to a limited number of embodiments, however, with the benefit of the above description, those skilled in the art should understand that other embodiments may be envisaged within the scope of the present disclosure described.

In addition, it should be noted that the language used in this specification is mainly selected for readability and teaching purposes, not for explaining or limiting the subject of the present disclosure. Therefore, without departing from the scope and spirit of the appended claims, many modifications and changes are obvious to those of ordinary skill in the art. For the scope of the present disclosure, the disclosure made by the present disclosure is illustrative rather than restrictive, and the scope of the present disclosure is defined by the appended claims.

1. A constant temperature circular accelerated loading test system, comprising:
a chassis;
a motor reducer and a circular loading wheel group in the middle of the chassis, wherein the motor reducer provides power for the circular loading wheel group, and the circular loading wheel group implements a rolling test on a ground during rotation;
a thermally insulated assembly on the chassis, wherein the circular loading wheel group is located in a thermally insulated inner cavity of the thermally insulated assembly;
a constant temperature unit on the chassis; and
a control cabinet on the chassis, wherein the control cabinet is connected to and controls the constant temperature unit and the motor reducer, respectively.

2. The constant temperature circular accelerated loading test system according to claim 1, wherein the thermally insulated assembly comprises a chassis thermally insulated inner cavity and a lower thermally insulated curtain, the chassis thermally insulated inner cavity has a cavity with an opening facing downwards, the circular loading wheel group is located in the cavity, and the lower thermally insulated curtain is wrapped at a lower part of the chassis thermally insulated cavity and sagged naturally to the ground.

3. The constant temperature circular accelerated loading test system according to claim, further comprising:
adjustable legs for adjusting a vertical height of the chassis.

4. The constant temperature circular accelerated loading test system according to claim 3, wherein the number of the adjustable legs is an even number, and the even-numbered adjustable legs are placed vertically and connected to the chassis symmetrically.

5. The constant temperature circular accelerated loading test system according to claim 1, further comprising:
a water bath fixing assembly on the chassis and below the circular loading wheel group;
wherein the water bath fixing assembly further comprises:
a water heating and circulation device on a side of the chassis; and
a water bath below the circular loading wheel group.

6. The constant temperature circular accelerated loading test system according to claim 1, further comprising:
a travel wheel assembly on a bottom of the chassis.
